(19) United States
(12) Patent Application Publication
(10) Pub. No.: US 2025/0119554 A1
(43) Pub. Date: Apr. 10, 2025

(54) METHOD OF ENCODING/DECODING AN IMAGE BASED ON REGION OF INTEREST

(71) Applicants: Electronics and Telecommunications Research Institute, Daejeon (KR); Myongji University Industry and Academia Cooperation Foundation, Yongin-si (KR)

(72) Inventors: Soon Heung JUNG, Daejeon (KR); Hyon Gon CHOO, Daejeon (KR); Sang Kyun KIM, Yongin-si (KR)

(21) Appl. No.: 18/912,471

(22) Filed: Oct. 10, 2024

(30) Foreign Application Priority Data
Oct. 10, 2023 (KR) 10-2023-0134681
Oct. 8, 2024 (KR) 10-2024-0136866

(51) Int. Cl. H04N 19/167; H04N 19/17; H04N 19/463

(52) U.S. Cl. CPC H04N 19/167; H04N 19/17; H04N 19/463

(57) ABSTRACT

A image encoding method according to present disclosure may comprise encoding an image based on a region of interest (ROI) including setting a ROI group, including the region of interest, in the image; converting the image based on the ROI group; and encoding a converted image. Here, the converted image may represent an image that a position of the ROI group is moved or a copped image generated to comprise the ROI group in the image.

### CROSS-REFERENCE TO RELATED APPLICATION

This application claims priority under 35 U.S.C § 119 to Korean Patent Application No. 10-2023-0134681, filed in the Korean Intellectual Property Office on Oct. 10, 2023, and to Korean Patent Application No. 10-2024-0136866, filed on Oct. 8, 2024, the entire contents of which are hereby incorporated by reference.

### BACKGROUND OF THE INVENTION

### Field of the Invention

The present disclosure relates to a video encoding/decoding method based on a region of interest and device therefor.

### Description of the Related Art

Conventionally, video encoding/decoding technology has improved video compression efficiency and image quality by considering the human visual system. However, future video encoding/decoding technology is expected to be widely used not only for human vision but also in machine vision fields such as surveillance, intelligent transportation, smart cities, and intelligent industry.

Accordingly, there is a need to develop video encoding/decoding technology by which high-efficiency compression and recognition accuracy can be obtained by simultaneously considering human vision and machine vision.

### SUMMARY OF THE INVENTION

Therefore, the present disclosure has been made in view of the above problems, and it is an object of the present disclosure is to reduce amount of data to be encoded/decoded by a pre-processing of an input image

An object of the present disclosure is to provide a method and a device for encoding/decoding an image converted based on a region of interest to enhance the compression efficiency while maintaining a performance of machine task.

An object of the present disclosure is to provide metadata to inverse-convert an image converted based on a region of interest into an original image.

The technical objects to be achieved by this disclosure are not limited to the technical objects mentioned above, and other technical objects not mentioned can be clearly understood by those skilled in the art from the description below.

In accordance with the present disclosure, the above and other objects can be accomplished by the provision of a method of encoding an image based on a region of interest (ROI) including setting a ROI group, including the region of interest, in the image; converting the image based on the ROI group; and encoding a converted image. Here, the converted image may represent an image that a position of the ROI group is moved or a copped image generated to comprise the ROI group in the image.

In accordance with the present disclosure, the method of encoding the image based on ROI may further include encoding a metadata for the converted image. Here, the metadata comprises a flag indicating whether the image is converted based on the ROI group or not.

In the method of encoding the image based on ROI accordance with the present disclosure, when the flag is encoded with a value indicating that the image is converted based on the ROI group, information representing an original position of the ROI region may be further encoded.

In the method of encoding the image based on ROI accordance with the present disclosure, information representing a moved potion of the ROI region may be further encoded.

In the method of encoding the image based on ROI accordance with the present disclosure, when the flag is encoded with a value indicating that the image is converted based on the ROI group, information representing a size of the ROI group or a size of the cropped image may be further encoded.

In the method of encoding the image based on ROI accordance with the present disclosure, information representing a size difference between the cropped image and the image may be further encoded.

In the method of encoding the image based on ROI accordance with the present disclosure, when a plurality of regions of interest are present in the image, the ROI group may be a minimum-sized rectangular region comprising the plurality of regions of interest.

In the method of encoding the image based on ROI accordance with the present disclosure, the ROI group may be moved with reference to a pre-defined position in the image, and the pre-define position may be a top-left position, top-right position, bottom-left position, bottom-right position or center position in the image.

In the method of encoding the image based on ROI accordance with the present disclosure, when a plurality of regions of interest are present in the image, each of the plurality of regions of interest may be set as a ROI group, and the converted image may be derived by moving each of a plurality of ROI groups in the image.

In accordance with the present disclosure, the above and other objects can be accomplished by the provision of a method of decoding an image based on a region of interest (ROI) including decoding an image from a bitstream; determining whether a decoded image is an image converted based on the region of interest; and in response to the decoded image being a converted image, generating a restored image by restoring a ROI group in the decoded image to an original position. Here, the converted image may represent an image that a position of the ROI group is moved or a copped image generated to comprise the ROI group.

In the method of decoding the image based on ROI accordance with the present disclosure, based on a flag decoded from the bitstream, it may be determined whether the decoded image is the converted image or not.

In the method of decoding the image based on ROI accordance with the present disclosure, when the flag indicates that the decoded image is the converted image, information representing the original position of the ROI group may be additionally decoded.

In the method of decoding the image based on ROI accordance with the present disclosure, when the flag indicates that the decoded image is the converted image, information representing a size of the ROI group or a size of the cropped image may be additionally decoded.

In the method of decoding the image based on ROI accordance with the present disclosure, information representing a size difference between the cropped image and the restored image may be additional decoded.

According to the present disclosure, a computer-readable recording medium on which instructions for performing the image encoding method or the image decoding method are recorded can be provided.

Additionally, according to the present disclosure, a computer-readable recording medium that stores data generated by the image encoding method can be provided.

### BRIEF DESCRIPTION OF THE DRAWINGS

FIG. 1 is a block diagram of a video encoder according to an embodiment of the present disclosure.

FIG. 2 is a block diagram of a video decoder according to an embodiment of the present disclosure.

FIG. 3 is a flowchart of an image encoding/decoding method based on a region of interest according to an embodiment of the present disclosure.

FIG. 4 is a drawing illustrating a region of interest in an image.

FIGS. 5 to 7 illustrate examples of reducing the number of blocks occupied by a region of interest by moving the position of the region of interest.

FIGS. 8 to 13 illustrate examples in which a plurality of regions of interest are included in an image.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

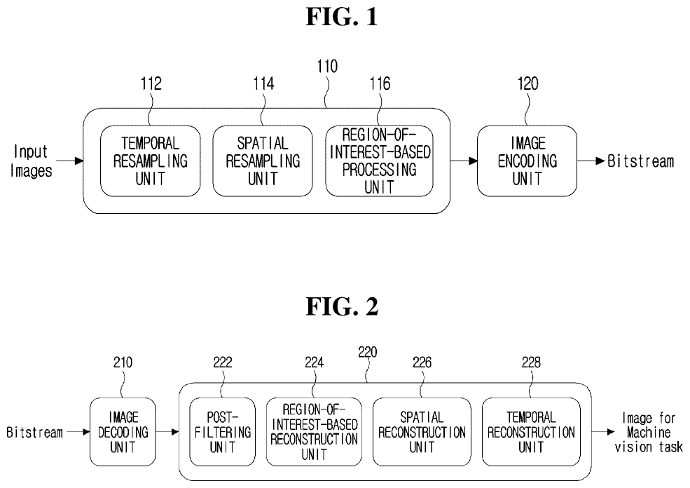

FIG. 1 is a block diagram of a video encoder according to an embodiment of the present disclosure.

Referring to FIG. 1, the video encoder may include a preprocessor 110 and an image encoding unit 120.

The preprocessor 110 performs a preprocessing process to convert input original images into images suitable for image encoding. Here, images input to the preprocessor 110 may be color or black-and-white images conforming to the YUV or YCbCr format.

The preprocessor 110 may include at least one of a temporal resampling unit 112, a spatial resampling unit 114, or a region-of-interest-based processing unit 116.

The temporal resampling unit 112 temporally resamples images. Only resampled images may be selected for image encoding. That is, encoding of some of the images input to the preprocessor 110 may be omitted through temporal resampling. For example, a 60 fps (frame per second) video may be converted into a 30 fps video by omitting odd-numbered images of the 60 fps video. Alternatively, images in a specific output order may be omitted by considering temporal redundancy between images.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The region-of-interest-based processing unit 116 sets a region of interest in an image such that image encoding/decoding is performed focusing on information important to machine inference tasks. The region-of-interest-based processing unit 116 may remove a background region excluding the set region of interest or adjust the size and/or location of the region of interest in the image, so that the region of interest is set to be encoded/decoded with high quality.

The image encoding unit 120 encodes the image output from the preprocessing unit 110. Meanwhile, the image encoding unit 120 may encode the image using conventional codec technology or a codec technology modified based on the conventional codec technology for VCM (Video Coding for Machine). As an example, the image encoding unit 120 may encode the image based on HEVC, VVC, or AV1. As a result of image encoding, a bitstream is generated and the generated bitstream may be transmitted to a video decoder.

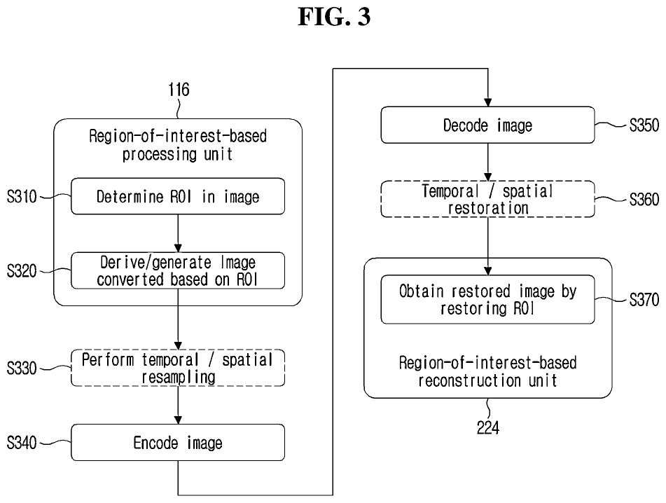

FIG. 2 is a block diagram of a video decoder according to an embodiment of the present disclosure.

Referring to FIG. 2, the video decoder may include an image decoding unit 210 and a post-processor 220.

The image decoding unit 210 decodes a bitstream received from the video encoding unit 110 to generate a decoded or reconstructed image. The image decoding unit 210 may decode the bitstream based on the codec technology used in the image encoding unit 120.

The post-processor 220 performs post-processing on the decoded image. Through post-processing, the size and frame rate of the images may be restored to match the original images.

The post-processor 220 may include at least one of a post-filtering unit 222, a region-of-interest-based reconstruction unit 224, a spatial reconstruction unit 226, or a temporal reconstruction unit 218.

The post-filtering unit 222 applies filtering to reduce a reconstruction error of a decoded image. For example, the post-filtering unit 222 may apply an in-loop filter to the decoded image. The in-loop filter may include at least one of a deblocking filter, a sample adaptive offset filter, a luma mapping chroma scaling (LMCS) filter, or an adaptive loop filter.

The region-of-interest-based reconstruction unit 224 obtains an image of the same size as an original image based on region-of-interest information. For example, when a cropped image is encoded such that a region of interest is included therein, the decoded image has a different size from the original image. Accordingly, the region-of-interest-based reconstruction unit may adjust the retargeted image to the original size. Here, the retargeted image may represent a decoded image or an image on which upscaling has been performed through the spatial reconstruction unit 226. Alternatively, when the size or position of a region of interest in an encoding target image has been adjusted, the region of interest-based reconstruction unit 224 may adjust the position and size of the region of interest in the retargeted image to match the original image.

The spatial reconstruction unit 226 performs upscaling on a decoded image. The decoded image may be reconstructed to be an image having the same size and/or spatial resolution as the original image through upscaling.

The temporal reconstruction unit 228 reconstructs an image at a temporal position where encoding/decoding has been omitted through temporal resampling. Specifically, the temporal reconstruction unit 228 may generate an image at a temporal position where encoding/decoding has been omitted through interpolation between decoded images.

Meanwhile, in order to perform reverse processing on the image processing performed in the preprocessor 110, additional information may be encoded and signaled. The post-processor 220 may perform post-processing on decoded images based on the additional information to generate images for machine inference. The additional information may be referred to as “metadata”.

Metadata may include at least one of temporal resampling information, spatial resampling information, or region-of-interest processing information.

The temporal resampling information may include at least one of a flag indicating whether temporal resampling has been performed or information indicating a temporal resampling rate.

For example, the flag indicates that temporal resampling has been performed when set to 1. In this case, information indicating a temporal resampling rate may be additionally encoded/decoded. When temporal resampling is performed, fewer images than the number of original images may be encoded/decoded. The video decoder can reconstruct images for which encoding/decoding has been omitted through temporal reconstruction.

On the other hand, the flag indicates that temporal resampling has not been performed when set to 0.

The temporal resampling rate may be represented as an exponent of 2. For example, a temporal resampling rate of 2\hat{ }N indicates that one of 2\hat{ }N images is selected as an encoding/decoding target image. For example, only images having a picture order count (POC) of a multiple of 2\hat{ }N can be encoded/decoded. Information representing the temporal resampling rate may represent the exponent (i.e., N) of the temporal resampling rate. As an example, the information may represent the exponent value of the temporal resampling rate or the value obtained by subtracting 1 from the exponent value.

The spatial resampling information may include at least one of a flag indicating whether spatial resampling has been performed or information indicating a scaling parameter for spatial resampling.

As an example, the flag indicates that spatial resampling has been performed when set to 1. In this case, information representing a scaling parameter may be additionally encoded. Specifically, information representing a horizontal scaling parameter and information representing a vertical scaling parameter may be encoded, respectively, and the encoded information may be signaled. When spatial resampling is performed, the size and/or spatial resolution of an image may be reduced. The video decoder may restore the size of a decoded image to the size of the original image or a pre-defined size, through spatial reconstruction. Meanwhile, information, indicating the pre-defined size, may be further encoded/decoded.

The flag indicates that spatial resampling has not been performed when set to 0.

The region-of-interest processing information may include at least one of image size information or region-of-interest information.

The image size information may include information indicating whether retargeting has been performed. If the retargeting flag is 1, it indicates that the retargeted image is encoded/decoded instead of the original image. On the other hand, if the retargeting flag is 0, it indicates that the original image is encoded/decoded as is.

The retargeted image indicates an image generated by performing at least one of resolution adjustment and position adjustment on at least one region of interest in the original image. Accordingly, the resolution or position of the region of interest in the retargeted image may be different from that of the original image. In addition, the size of the retargeted image may be the same as or smaller than that of the original image.

When retargeting is allowed (i.e., if the retargeting flag is 1), the size information of the retargeted image may be encoded/decoded. The size information of the retargeted image may include width information of the image and height information of the image.

Meanwhile, information indicating the size difference between the original image and the retargeted image may be additionally encoded/decoded. For example, information indicating whether a size difference between the size of the retargeted image and the size of the original image is encoded/decoded or not may be encoded/decoded.

For example, when the information, indicating whether the size difference is encoded/decoded or not, is 0, it indicates that the size difference between the retargeted image and the original image is not encoded/decoded. On the other hand, when the information, indicating whether the size difference is encoded/decoded or not, is 1, it indicates that the size difference between the retargeted image and the original image is encoded/decoded. In this case, information indicating the size difference between the size of the retargeted image and the size of the original image may be additionally encoded/decoded.

The information representing the size difference indicates the size difference between the original image and the retargeted image. Information representing the size difference in the horizontal direction and information representing a size difference in the horizontal direction may be encoded and signaled, respectively.

The region-of-interest information may include at least one of a flag indicating whether a region of interest is present, information on the number of regions of interest, a scaling parameter of a region of interest, or position information of a region of interest.

For example, when the flag is 1, it indicates that information on a region of interest may be encoded/decoded. In this case, at least one of the number of regions of interest, scaling parameter information of a region of interest, position information of a region of interest, or size information of a region of interest may be additionally encoded/decoded.

On the other hand, when the flag is 0, it indicates that a region of interest is not present.

The information on the number of regions of interest indicates the number of regions of interest. Meanwhile, the number of regions of interest may be calculated in units of image groups including at least one image.

A scaling parameter of a region of interest represents the scaling parameter with respect to the region of interest. Depending on the scaling parameter of the region of interest, the size of the region of interest may be adjusted.

Scaling parameter information of a region of interest may include information indicating whether the scaling parameter of the region of interest is updated. If the information, indicating whether the region of interest is updated or not, indicates that the scaling parameter of the region of interest will not be updated, the scaling parameter of the region of interest may be set to a default value or the same value as in the previous frame. On the other hand, when the information, indicating whether the region of interest is updated or not, indicates that the scaling parameter of the region of interest needs to be updated, the information indicating the scaling parameter of the region of interest may be additionally encoded/decoded.

Meanwhile, scaling parameter information of a region of interest may be encoded/decoded individually for each region of interest.

Position information of a region of interest indicates the position of the region of interest in the original image. The horizontal position (i.e., x-axis coordinate) information and vertical position (i.e., y-axis coordinate) information of the region of interest may be encoded/decoded.

Size information of a region of interest indicates the size of the region of interest in the original image. The horizontal size (i.e., width) information and the vertical size (i.e., height) information of the region of interest may be encoded/decoded.

As described above, according to the present disclosure, through the preprocessing process of the image, the encoding/decoding efficiency of the image may be improved while maintaining the machine task performance.

In the following embodiments, a method of encoding/decoding an image focusing on a region of interest will be described in detail.

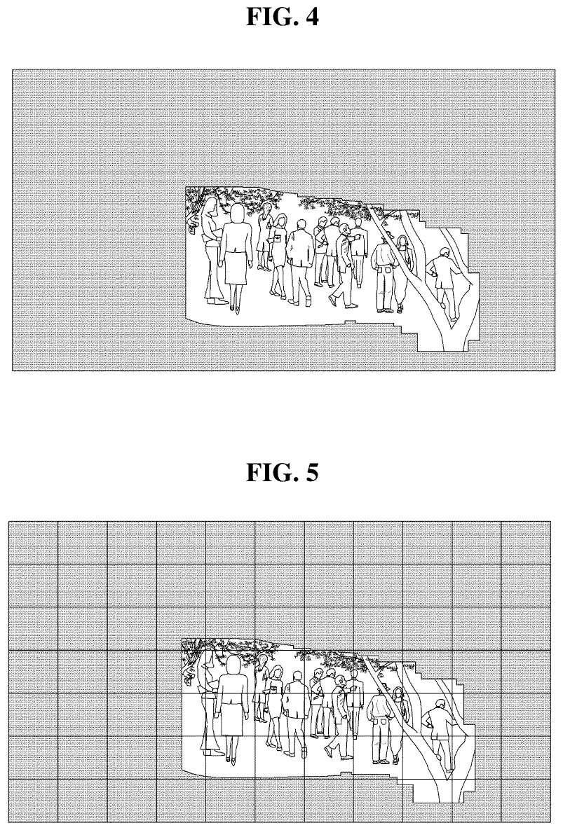

FIG. 3 is a flowchart of an image encoding/decoding method based on a region of interest according to an embodiment of the present disclosure.

First of all, in the image encoder, a region of interest in the image may be determined S310. Specifically, in the region-of-interest-based processing unit 116 in the image encoder, the image may be divided into a region of interest and a background region.

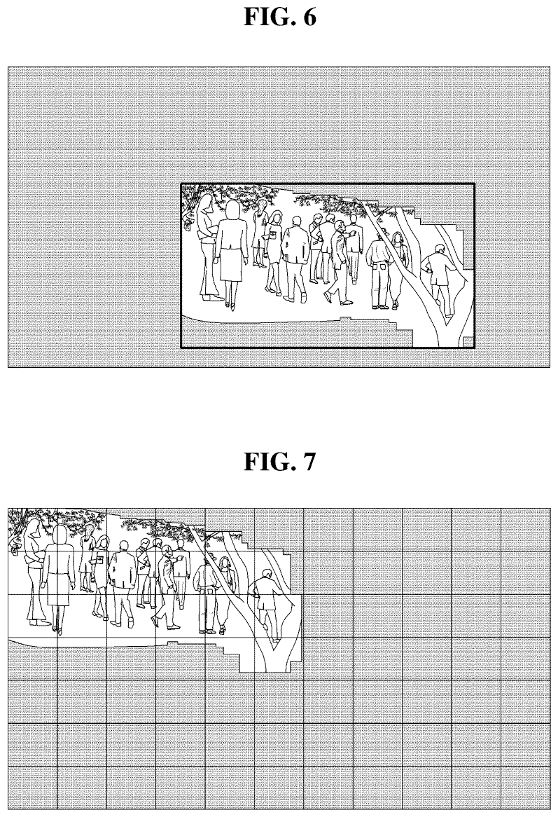

FIG. 4 is a drawing illustrating a region of interest in an image.

Specifically, FIG. 4 illustrates an image in which a background region, except for a region of interest including main objects in the image, is removed.

By removing a background region except for a region of interest in the image, the encoding/decoding efficiency may be improved while maintaining the machine task performance.

Meanwhile, the determination of the region of interest may be performed in units of images or in units of image groups. Here, an image group may be composed of multiple images. For example, images belonging to an intra period or a predefined number of images may be set as an image group.

When the region of interest is set int unis of image groups, the regions of interest searched in each image in the image group may be accumulated in consideration of the encoding/decoding efficiency. In other words, the regions of interest of each image included in the image group may be set by accumulating the regions of interest searched from each image included in the image group.

Meanwhile, conventionally, image encoding/decoding is performed in units of blocks. Accordingly, if the number and/or size of blocks occupied by the region of interest is reduced, it can be expected that image encoding/decoding efficiency can be improved.

To this end, the image encoder may generate/derive a image converted based on the region of interest S320.

Here, the image converted based on the region of interest may be one in which the position of the region of interest in the image is moved to a predefined position. The predefined position may be the top left position, top right position, bottom left position, bottom right position, or center position of the image.

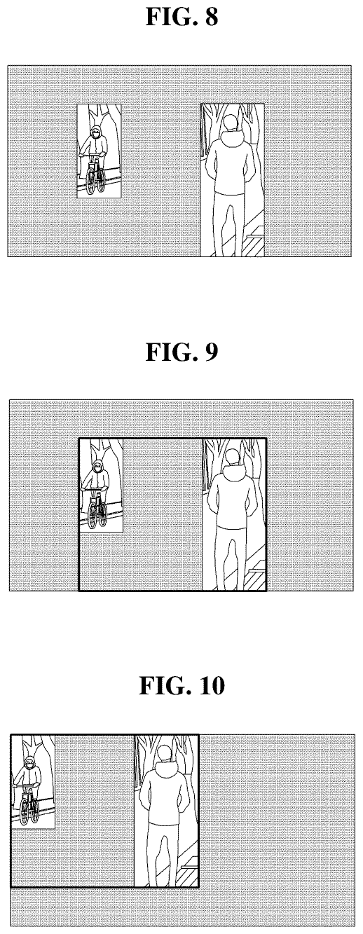

FIGS. 5 to 7 illustrate examples of reducing the number of blocks occupied by a region of interest by moving the position of the region of interest.

FIG. 5 illustrates the initial (original) position of the region of interest in the image.

In order to move the position of the region of interest in the image, a rectangular region including the region of interest may be set as a group of region of interest (hereinafter ROI group). For example, as in the example illustrated in FIG. 6, a minimum-sized rectangular region including the entire region of the region of interest may be set as a ROI group.

The ROI group may be a rectangular region comprising one or more region of interest.

The ROI group may be a region of the rectangular shape including one or more region of interest.

Since the ROI group has a rectangular shape, the position and size of the region of interest may be defined based on the coordinates of two corners of the rectangle. For example, the position and size of the ROI group in the image may be represented as a pair of a coordinate of top-left pixel and a coordinate of bottom-right pixel of the ROI group.

Meanwhile, when the width and height of the ROI group are referred to as ROIwidth and ROIheight, respectively, the coordinate of the bottom-right pixel of the ROI group may be equal to a coordinate derived by adding (ROIwidth, ROIwidth) to the top-left pixel coordinate of the ROI group.

After setting a ROI group as a rectangular shape, the ROI group may be moved to the top left of the image, as in the example shown in FIG. 7.

Comparing FIG. 5 and FIG. 7, it can be confirmed that the number of blocks occupied by the region of interest is reduced by moving the region of interest to the top left position of the image.

Meanwhile, the position of the ROI group may be moved to a different reference position, not the top left position. For example, the ROI group may be moved to a top right position, bottom left position, bottom right position, or central position of the image.

If there are multiple available reference positions, information indicating the reference position of the ROI group among the multiple reference positions may be encoded and signaled.

If a plurality of regions of interest are present, the ROI group may be set to include the plurality of regions of interest.

Alternatively, each of the plurality of regions of interest may be set as a ROI group, or the plurality of regions of interest may be classified into a plurality of ROI groups.

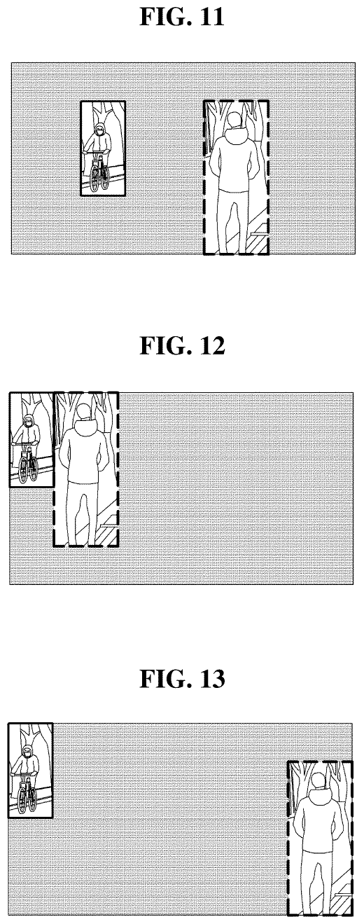

FIGS. 8 to 13 illustrate examples in which a plurality of regions of interest are included in an image.

In FIG. 8, it is illustrated that two regions of interest are included in an image.

In this case, as in the example illustrated in FIG. 9, a rectangular region including two regions of interest may be set as a ROI group.

In addition, as in the example illustrated in FIG. 10, a rectangular region including two regions of interest may be moved to the top left position of the image to encode/decode the image.

Alternatively, as in the example illustrated in FIG. 11, each of the two regions of interest may be set as a ROI group.

In this case, as in the example illustrated in FIG. 12, both ROI groups may be moved to the top left position of the image.

Alternatively, as in the example illustrated in FIG. 13, one of the two ROI group may be moved to the top left position of the image, and the other may be moved to the bottom right position of the image.

Meanwhile, information related to the movement of the ROI group may be encoded and signaled to the image decoder. Specifically, the image decoder may decode the image in which a position of the ROI group is moved, and then, based on the information related to the movement of the ROI group, the position of the ROI group in the decoded image may be moved to its original position.

As another example, the image converted based on the ROI group may be a cropped image generated by cropping the original image to comprise the ROI group. The cropped image may be generated by cropping a region excluding the ROI group in the original image.

Specifically, the cropped image may be generated by cropping a region excluding blocks (e.g., CTUs) occupied by the ROI group.

Meanwhile, if a plurality of ROI groups are included in the image, the cropped image may be generated by cropping a region excluding a rectangular region comprising the plurality of ROI groups.

In order to restore an image of the same size as the original image in the decoder, information for determining the sizes of each of the original image and the cropped image may be encoded/decoded. In addition, in order to move the region of interest to its original position in the image whose size is converted to match the original image, the position information of the ROI group may also be encoded and signaled.

Meanwhile, the image converted based on the region of interest may be encoded through at least one of temporal resampling or spatial resampling S330, S340. Alternatively, the image converted based on the region of interest may be generated/derived after at least one of temporal resampling or spatial resampling is performed.

As another example, temporal resampling and spatial resampling may be omitted, and only region of interest processing may be performed.

In the image decoder, an image converted based on a region of interest may be decoded S350. Then, by using metadata, the decoded image may be converted (i.e., inverse-converted) into an image of the same size as the original image, or the region of interest in the decoded image may be moved to the original position, thereby obtaining a restored image S370.

Meanwhile, at least one of temporal restoration or spatial restoration may be performed on the decoded image S360, and a restored image may be obtained through restoration of the region of interest for the image on which temporal restoration or spatial restoration has been performed S370. Alternatively, after restoration of the region of interest is performed, at least one of temporal restoration or spatial restoration may be performed to obtain the restored image.

As another example, the restored image may be obtained by omitting the temporal restoration and spatial restoration, and only performing restoration of the region of interest.

In the image decoder, in order to move the region of interest to the original position, information on the location of the region of interest may be added/decoded as metadata.

Specifically, when the ROI group is a rectangular region, information for determining coordinates of the top left position and the bottom right position corresponding to the original position of the ROI group, and coordinates of the top left position and the bottom right position corresponding to the moved position of the ROI group may be encoded and signaled.

Table 1 shows the syntax structure that comprises the position information of the ROI group.

TABLE 1

| | Descriptor |
|---|---|
| roi_metadata( ) { | |
| roi_metadata_id | |
| frame_id | |
| roi_based_processing_flag | u(1) |
| if( roi_based_processing_flag ) { | |
| roi_group_shift_flag | u(1) |
| if( roi_group_shift_flag ) { | |
| num_roi_group | |
| for(i=0;i<num_roi_group;i++){ | |
| ori_pos_roi_group_lefttop_x[i] | |
| ori_pos_roi_group_lefttop_y[i] | |
| ori_pos_roi_group_width[i] | |
| ori_pos_roi_group_height[i] | |
| shifted_pos_roi_group_lefttop_x[i] | |
| shifted_pos_roi_group_lefttop_y[i] | |
| } | |
| } | |
| } | |

In Table 1, the syntax roi_metadata_id indicates the identifier of the metadata structure roi_metadata that includes information related to the region of interest.

The syntax frame_id indicates the identifier of the image.

The syntax roi_based_processing_flag indicates whether the processing based on the region of interest is performed on the current image. If the image converted based on the region of interest is encoded/decoded, the value of the syntax roi_based_processing_flag may be set as 1. On the other hand, if the image that has not been converted is encoded/decoded, the value of the syntax roi_bsed_processing_flag may be set as 0.

Meanwhile, information indicating whether the input image has been converted based on the region of interest may be encoded/decoded. For example, the syntax roi_group_shift_flag may indicate whether the ROI group in the image is moved. If the ROI group in the image is moved to a predefined position, the value of the syntax roi_group_shift_flag may be set to 1. Otherwise, the value of the syntax roi_group_shift_flag may be set to 0.

As another example, although not shown in Table 1, a syntax (e.g., roi_cropped_flag) that indicates whether a cropped image, including the region of interest in the image, is encoded or not may be encoded/decoded.

That is, based on the syntax roi_group_shift_flag or the syntax roi_cropped_flag, whether the input image is converted based on the region of interest may be specified.

Meanwhile, the syntax roi_group_shift_flag or the syntax roi_cropped_flag may be encoded/decoded when the syntax roi_based_processing_flag indicates that region-of-interest-based processing is performed.

As another example, it is also possible to determine whether region-of-interest-based processing is performed based on the syntax roi_group_shift_flag or the syntax roi_cropped_flag without the syntax roi_based_processing_flag.

Alternatively, it is also possible to determine, based on the syntax roi_based_processing_flag without the syntax roi_group_shift_flag or the syntax roi_cropped_flag, whether the image converted based on the region of interest is encoded or not.

The syntax num_roi_group indicates the number of ROI groups. Instead of the syntax num_roi_group, a syntax having a value derived by subtracting a predefined integer from the number of ROI groups, for example, num_roi_group_minus1, may be encoded/decoded. Meanwhile, the syntax num_roi_group may be encoded and signaled when region of interest based processing is performed, for example, when at least one of the syntax roi_based_procesing_flag, the syntax roi_group_shift_flag, or the syntax roi_cropped_flag is 1.

Meanwhile, the position information and the size information for each ROI group may be encoded/decoded. When the number of ROI groups is plural, the position information and the size information may be encoded/decoded for each of the plural ROI groups.

For example, the syntax ori_pos_roi_group_lefttop_x[i] may represent the horizontal pixel coordinate of the top left of the i-th ROI group before the movement. the syntax ori_pos_roi_group_lefttop_y[i] may represent the vertical pixel coordinate of the top left of the i-th ROI group before the movement.

The syntax ori_pos_roi_group_width[i] may represent the width of the i-th ROI group. The syntax ori_pos_roi_group_height[i] may represent the height of the i-th ROI group.

The syntax shifted_pos_roi_group_lefttop_x[i] may represent the horizontal pixel coordinate of the top left of the i-th ROI group after the movement. The syntax shifted_pos_roi_group_lefttop_y[i] may represent the vertical pixel coordinate of the top left of the i-th ROI group after the movement.

Meanwhile, when the ROI group is moved to the top left position of the image, or when the image is cropped to include the ROI group, the top left position of the region of interest may have (0, 0). Accordingly, when the ROI group is moved to a predefined position in the image, or when the image is cropped to include the ROI group, the syntax shifted_pos_roi_group_lefttop_x[i] and the syntax shifted_pos_roi_group_lefttop_y[i] indicating the position of the ROI group after the movement may not be encoded/decoded.

Meanwhile, information indicating the size difference between the cropped image and the original image may be encoded/decoded. Alternatively, information indicating the size difference between the size of the cropped image and the restoration target size of the image may be encoded/decoded. Here, the restoration target size may indicate the size of the restored image that is finally obtained in the image decoder for performing the machine task.

For example, a flag picture_size_difference_flag indicating whether information indicating the difference between the size of the cropped image and the original image, or the difference between the size of the cropped image and the restoration target size is encoded/decoded or not may be encoded/decoded. If the flag is 1, the syntax picture_difference_width and the syntax picture_difference_height, which represent the size difference between the size of the cropped picture and the size of the original image, or the size of the cropped picture and the restoration target size, may be encoded/decoded.

The syntax picture_difference_width may represent the size difference in the horizontal direction, and the syntax picture_difference_height may represent the size difference in the vertical direction.

Based on the metadata structure of Table 1, the image decoder may determine whether the decoded image is an image converted based on the region of interest. For example, based on the syntax roi_group_shift_flag, it may be determined whether the decoded image is an image in which the position of the ROI group is shifted, or based on the syntax roi_cropped_flag, it may be determined whether the decoded image is an image cropped to include the ROI group.

If the decoded image corresponds to an image converted based on the region of interest, the image decoder may restore the image based on the number information, position information, and size information of the ROI group.

For example, using the original position information of the ROI group, the position of the region of interest in the decoded image may be moved to the original position to obtain a restored image.

Alternatively, using the difference information between the size of the cropped image and the restoration target size and the original position information of the ROI group, the size of the decoded image may be adjusted and the position of the ROI group in the adjusted sized image may be determined to obtain a restored image.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

According to the present disclosure, there is an effect of reducing among of data to be encoded/decoded by a pre-processing of an input image.

According to the present disclosure, there is an effect of enhancing the compression efficiency while maintaining a performance of machine task by encoding/decoding an image converted based on a region of interest.

According to the present disclosure, there is an effect of providing a metadata to inverse-convert an image converted based on a region of interest into an original image.

What is claimed is:

1. A method of encoding an image based on a region of interest (ROI), the method comprising:
setting a ROI group, including the region of interest, in the image;
converting the image based on the ROI group; and
encoding a converted image,
wherein the converted image represents an image that a position of the ROI group is moved or a copped image generated to comprise the ROI group in the image.

2. The method of claim 1, wherein the method further comprises encoding a metadata for the converted image, and
wherein the metadata comprises a flag indicating whether the image is converted based on the ROI group or not.

3. The method of claim 2, wherein when the flag is encoded with a value indicating that the image is converted based on the ROI group, information representing an original position of the ROI region is further encoded.

4. The method of claim 3, wherein information representing a moved potion of the ROI region is further encoded.

5. The method of claim 2, wherein when the flag is encoded with a value indicating that the image is converted based on the ROI group, information representing a size of the ROI group or a size of the cropped image is further encoded.

6. The method of claim 6, wherein information representing a size difference between the cropped image and the image is further encoded.

7. The method of claim 1, wherein when a plurality of regions of interest are present in the image, the ROI group is a minimum-sized rectangular region comprising the plurality of regions of interest.

8. The method of claim 7, wherein the ROI group is moved with reference to a pre-defined position in the image, and
wherein the pre-define position is a top-left position, top-right position, bottom-left position, bottom-right position or center position in the image.

9. The method of claim 1, wherein when a plurality of regions of interest are present in the image, each of the plurality of regions of interest is set as a ROI group, and
wherein the converted image is derived by moving each of a plurality of ROI groups in the image.

10. A method of decoding an image based on a region of interest (ROI), the method comprising:
decoding an image from a bitstream;
determining whether a decoded image is an image converted based on the region of interest; and
in response to the decoded image being a converted image, generating a restored image by restoring a ROI group in the decoded image to an original position,
wherein the converted image represents an image that a position of the ROI group is moved or a copped image generated to comprise the ROI group.

11. The method of claim 10, wherein based on a flag decoded from the bitstream, it is determined whether the decoded image is the converted image or not.

12. The method of claim 11, wherein when the flag indicates that the decoded image is the converted image, information representing the original position of the ROI group is additionally decoded.

13. The method of claim 11, wherein when the flag indicates that the decoded image is the converted image, information representing a size of the ROI group or a size of the cropped image is additionally decoded.

14. The method of claim 13, wherein information representing a size difference between the cropped image and the restored image is additional decoded.

15. A non-transitory computer readable recording medium storing instructions for performing a method of encoding an image based on a region of interest (ROI), the method comprises:
setting a ROI group, including the region of interest, in the image;
converting the image based on the ROI group; and
encoding a converted image,
wherein the converted image represents an image that a position of the ROI group is moved or a copped image generated to comprise only the ROI group in the image.
